(19) United States
(12) Patent Application Publication
(10) Pub. No.: US 2011/0218885 A1
(43) Pub. Date: Sep. 8, 2011

(54) SYSTEM AND METHOD FOR SUPPLY CHAIN AND RELATIONSHIP MAPPING

(76) Inventors: Sarah Manski, Madison, WI (US); Ben Manski, Madison, WI (US)

(21) Appl. No.: 13/043,364

(22) Filed: Mar. 8, 2011

Related U.S. Application Data
(60) Provisional application No. 61/311,464, filed on Mar. 8, 2010.

(51) Int. Cl. G06Q 30/00

(52) U.S. Cl. 705/27.1; 705/347; 705/1.1

(57) ABSTRACT

A method for providing on online consumer driven environmentally sustainable product database. The method includes steps of providing a greenness rating for at least one product and/or service; providing a dynamically linked supply chain map of the at least one product and/or service; and providing a platform for consumers to purchase the at least one product and/or service.

### CROSS-REFERENCE TO RELATED APPLICATIONS

This application claims priority to U.S. Provisional Patent Application No. 61/311,464 filed Mar. 8, 2010, the content of which is incorporated herein by reference in its entirety.

### FIELD OF THE INVENTION

Various embodiments of the present invention relate generally to online retail services. Particularly, various embodiments of the present invention relate to online retail services and networking related to green and environmentally sustainable products.

### BACKGROUND OF THE INVENTION

It would be particularly advantageous to provide an online marketplace that leverages economic relationships as a basis of a connection or link between consumers, retailers and product/service providers. It would be advantageous to provide such an online marketplace that that is focused upon the green consumer and sustainability interests. It would be a further advantage if supply chain maps were provided.

### SUMMARY

In one embodiment, the invention provides a method for providing on online consumer driven environmentally sustainable product database. The method includes steps of providing a greenness rating for at least one product and/or service; providing a dynamically linked supply chain map of the at least one product and/or service; and providing a platform for consumers to purchase the at least one product and/or service.

Other aspects of the invention will become apparent by consideration of the detailed description and accompanying drawings.

### BRIEF DESCRIPTION OF THE FIGURES

FIG. 1 is a block diagram of an exemplary system in accordance with at least one embodiment of the present invention.

FIGS. 2A-2CE are logos associated with various certifications listed in the Table according to at least one embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

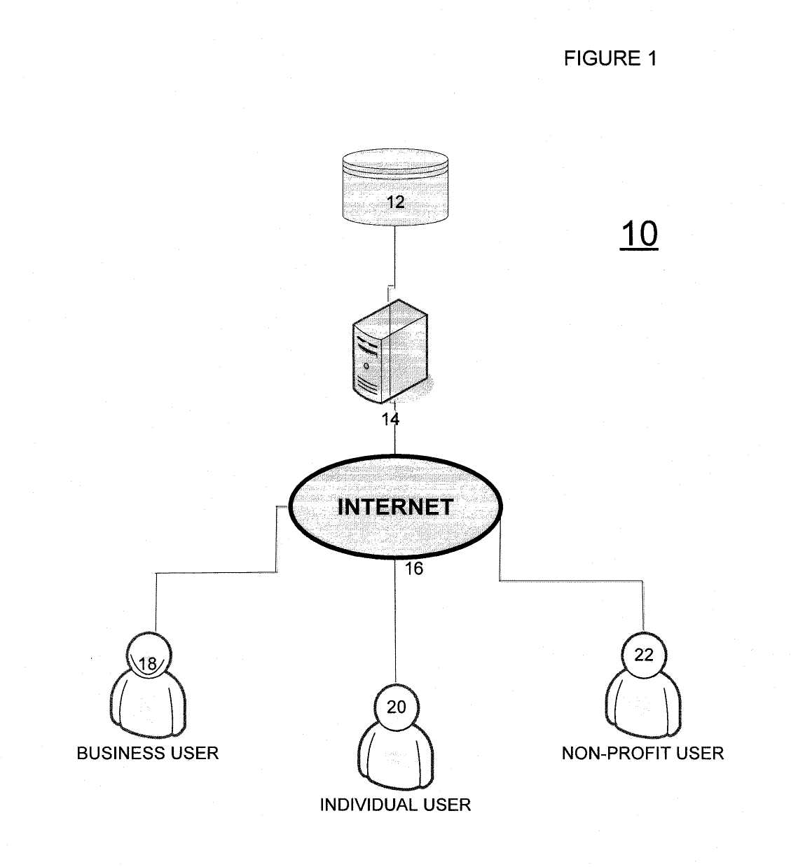

Briefly, described in one aspect, a business supply chain and relationship system 10 is provided in FIG. 1. The system 10 includes a database 12, a processor/server 14 and Internet 16. Users of the system 10 can be selected from a business user 18, individual user 20, and non-profit user 22. It is contemplated that the system 10 can be accessed through a variety of computing means known in the art, such as a laptop computer, desktop computer, smartphone, cell phone and/or other mobile computing device.

The system 10 provides a platform for proactively providing connections that link related green goods and services, displaying a supply chain for individual products and of the green and/or environmentally sustainable economy overall. The system 10 facilitates links between green businesses and sustainable partners, but also between green businesses, target markets, individual customers and other members of a network of green/environmentally sustainable users.

Each business can “pair” with their business partners; those they buy from, those that add value to their product, those they sell to and their customers. Individuals and non-profits are able to set-up separate profiles from businesses. Business users are able to display their products and sell them through the system 10.

In accordance with at least one embodiment of the present invention is a method for showing relationships between companies, non-profits, products, and people. The system 10 provides businesses with online profiles for themselves and their products, displaying their products' lifecycles, linking to business partners, highlighting their eco-labels, blogging on their green business practices, and using a shopping cart to engage in direct sales. The system 10 enables consumers to review businesses and products by color-coded indicators including but not limited to: Quality, Service, Environment, Labor, Community, set up personal profile pages, and search by industry, certification standards, location, supply chain, and more. Consumers will also be able to create personalized shopping lists by checking a box listed next to a product.

Embodiments of the present system include an eco-social/green business network resembling a blend of wiki, social and professional networking sites, including a community of green entrepreneurs and individuals who can converge online to share information in a way that promotes symbiosis and cultivates opportunity. By bringing the eyes of the green and/or environmentally sustainable product pairing community to bear on green claims, the goal is to achieve consensus on which businesses meet genuine standards and which fall short of green criteria. In the same way that wikis can benefit from a mass of contributors, embodiments of the present invention will bring together a plurality of voices that will help its community distinguish between valid green claims and those that are downright prevaricative.

According to at least one embodiment of the present invention, the system 10 is an online website featuring advertising and commercial information about environmentally conscious/sustainable and/or green products. A Products feature on the website will feature different classes of products, including actual consumable goods (ie, handmade wool sweaters) for businesses with many products or made-to-order, a specific product or a service (ie legal consulting for activists). Each product can include an arbitrary URL link which the user can assign to it. This link can then be directed to an external store's product page (if the user already has a store), or to a Store page for that user connected to the system 10, or for that user/product type, or for that user/product, etc.

In accordance with at least one embodiment of the present invention, the database 12 includes three user types: Individual, Business, and Non Profit Manager. A “user” refers to a single user account on the system 10. Each User can select multiple user types to be associated with her account. User is required to select at minimum of one user type.

User profiles can include the following exemplary default fields/features (available to ALL user types): Blog, email feature, Wishlist, Existing Pairs (other businesses, individuals, and non profit managers), Suggested Pairs (businesses, individuals, non-profit organizations (NPOs) and products), Photo/Logo, email address and username.

Business Profiles can have, be example, features selected from the group comprising: Business Name, Unlimited (or limited) number of products, a box with the logos of the eco-labels associated with the business, Manufacturing Partners, Sales Partners, Use Partners, Recycling Partners and Display consumer ratings for each category. Individual Profiles can also have the additional features which include Products Reviewed and Businesses Reviewed.

Non-profit business profiles can be set up to have the same type of profile as businesses, and/or include the following profile elements: Unlimited Products, Current Members, People We Would Like to Join, Current Supporters, People Doing Good Work, Products Reviewed and Businesses Reviewed.

A Product can include the following fields/features, all of which will be updatable by the product owner through the their online profile user settings page: consumer ratings (ratings are made by any user), a link to the shopping cart where it can be purchased, displays the Existing Pairs of the user/business who owns the product, Where is manufactured, Where its sold, What products with which it is used, Where it is recycled, displays other products made by the same business and News about the product.

The online website can include, by example, a dynamic and interactive visualization module that displays member businesses in a grid. An exemplary grid can include the following scheme:
The left column is “Buyers”
The right column is “Suppliers”
The middle column features the “Selected” profile box, dead center row.
The elements in the middle column above the “Selected” profile are those listed as “Service Providers”
The elements in the middle column below the “Selected” profile are those listed as “Clients”

Users viewing the business profile page can view several things: a photo of the business logo, a box containing photos of some of the business' products, a box with the logos of the business' partners, a box with the logos of suggested business partners, a box with the businesses wishlist, a box with the logos of the eco-labels associated with the business, a box with photos of individual people who have paired with this business, a box showing their Manufacturing Partners, a box showing their Sales Partners, a box showing their Use Partners, a box showing their Recycling Partners.

The product page can have a similar look and feel to the business profile page and can include several things: a photo of the product, a box showing the product's Manufacturing Partners “Made By”, a box showing the product's Sales Partners “Sold Here”, a box showing the product's Use Partners “Pairs Well With”, a box showing the product's Recycling Partners. The product page will also include the opportunity for users who are logged in to rate the product.

Users can choose from the three (3) user types (Individual, Business, NPO). They must choose at least one at any given time and can activate/deactivate these user types at any time. For each of the User Types, there can be an additional set of data points to fill out. Businesses are able to manage their products.

Individual profile pages will include a photo of the individual, a box of their paired products, a box of their paired businesses, a box of the products they've reviewed, how many products they're reviewed, how many businesses they've reviewed, a blog feature, a box containing the non-profts they're involved with, a box containing their wishlist, a link to an email feature, etc. Individuals should be encouraged to invite their friends through a module that connects to their yahoo or gmail address books.

Business owners can enter unlimited number of products (Add Product link). On the product profile pages we should have them enter in the email addresses of their sales, manufacturing, use, and recycling partners so that the partners will get an email encouraging them to sign up for PosiPair. Business will be encouraged to invite their employees through a module that connects, by example, to their yahoo or gmail address books.

Business, product, individual and non-profit user/products can have a user/product pairing function. By example, a link below their photo that says “click to pair”. When a business wants to pair with another business they will click the link and a menu will appear asking them to check the boxes that are related to the pairing criteria of interest, such as: our products are sold here, our products are made here, our products work well with their products, our products are recycled here. Depending on the criteria selected, the business checks, will effect where the paired partner ends up on the businesses profile page. By example, there can be a variety of criteria, such as: Manufacturing Partners, Sales Partners, Use Partners, Recycling Partners.

When a business wants to pair a product with another product they will click the “click to pair” link and a menu will appear asking them to check the boxes that are related to the pairing such as: this product is are sold here, this product is are made here, this products pairs well with that product, this products is recycled here. Depending on the box the product checks, will effect where the paired product ends up on the products profile page, because we with have at least four separate boxes: Manufacturing Partners, Sales Partners, Use Partners, Recycling Partners.

When an individual wants to pair with a business or product they will click the “click to pair” link with a product or business, a menu will appear asking them for the option to comment on the product or business and rate the business or product on a scale of one to six stars in each of the following categories with an open-ended “Please tell the world what you think” box below each category: Price, Quality, Convenience, Packaging, Labor, Local, closed loop, non extraction, climate change, Recycle ability and Healthfulness.

When a non-profit wants to pair with a product, they will, by example, a menu will appear asking them for the option to comment on the product or business and rate the business or product on a scale of one to six stars in each of the following categories with an open-ended “Please tell the world what you think” box below each category: Price, Quality, Convenience, Packaging, Labor, Local, closed loop, non extraction, climate change, Recycle ability and Healthfulness.

When a non-profit wants to pair with an individual they can, by example, select criteria from a menu that applies to this person, such as current member, we'd like you to join, current supporter, someone doing good work. Depending on the box the non-profit checks, this can effect where the individual ends up on the products profile page, because there can be a plurality of boxes, such as: Current Members, People We Would Like to Join, Current Supporter, Someone Doing Good Work.

Each business owner can have a box on their profile page called what we want for a greener tomorrow. This will be an open ended box with instructions at the top reading: “Only through honest dialog we can move forward together. Please list here those business practices that aren't as green or sustainable as you would like and what you need to run your company and produce your products in a more environmentally friendly manner.” This is an example of providing green quality of its members through a community-driven comment system.

Each individual can have a box on their profile page called what I want for a greener tomorrow. This will be an open ended box with instructions at the top reading: “Only through honest dialog we can move forward together. Please list here what you need to live a more sustainable lifestyle.”

Each non-profit can have a box on their profile page called what we want for a greener tomorrow. This will be an open ended box with instructions at the top reading: “Only through honest dialog we can move forward together. Please list here those business practices that aren't as green or sustainable as you would like and what you need to run your company and produce your products in a more environmentally friendly manner.”

When an individual enters a search term for a product such as “cookies”, they will be taken to a separate webpage that has a similar color scheme but is an elastic search webpage. On the elastic list page similar in functionality to They will be able to sort by: Price (high to low), Proximity (near to their home or to farther away), Union Made (yes or no), Overall Rating (high to low). The products will appear at the bottom of this webpage and an individual will be able to click on the product photo which will take them to the product's profile webpage.

When an individual searches for a non-profit, they will be able to sort by: Focus (Labor, Democracy, Environment, Animal Rights, Prison Reform), Proximity (near to their home or to farther away), Type (Local or National), and a variety of additional criteria. The non-profits will appear at the bottom of this webpage and an individual will be able to click on the non-profit photo which will take them to the nonprofit's profile webpage.

When an individual searches for a business, they will be able to sort by: Proximity (near to their home or to farther away), Type (Local or National Chain), Labor (Union or Non-Union), Overall Rating (high to low), and a variety of additional criteria. The businesses will appear at the bottom of this webpage and an individual will be able to click on the business photo which will take them to the business' profile webpage.

Each business and product will have a “click to comment” link and individuals will be able to rate the business or product, by example, on a scale of one to six stars in each of the following categories with an open-ended “Please tell the world what you think” box below each category: Price, Quality, Convenience, Packaging, Labor, Local, closed loop, non extraction, climate change, Recycle ability and Healthfulness.

A business pairing feature can be provided for businesses that are in similar industries, individuals who are paired to similar products. For non-profits, individuals who are members of non-profits in similar areas of focus, by example. For individuals, products connected to people they are paired with prefer, by example.

An exemplary homepage schema for an individual includes viewing a new see a business profile page. The business shown on the home page can be different everyday drawn from the pool of businesses within the database 12. Users can see on the business profile page several things, by example: a photo of the business logo, a box containing photos of some of the business' products, a box with the logos of the business' partners, a box with the logos of suggested business partners, a box with the businesses wishlist, a box with the logos of the eco-labels associated with the business, a box with photos of individual people who have paired with this business, a box showing their Manufacturing Partners, a box showing their Sales Partners, a box showing their Use Partners, a box showing their Recycling Partners.

Each of the products can be linked to their own separate web profile page. The product webpage will have a similar look and feel to the business profile page and will include several things, by example: a photo of the product, a box showing the product's Manufacturing Partners “Made By”, a box showing the product's Sales Partners “Sold Here”, a box showing the product's Use Partners “Pairs Well With”, a box showing the product's Recycling Partners.

By example, environmentally sustainable and/or green consumers rely upon a variety of certifications to ensure that the products and companies they support. The following Table is a list of exemplary certifications and brief descriptions for a variety of different types of products.

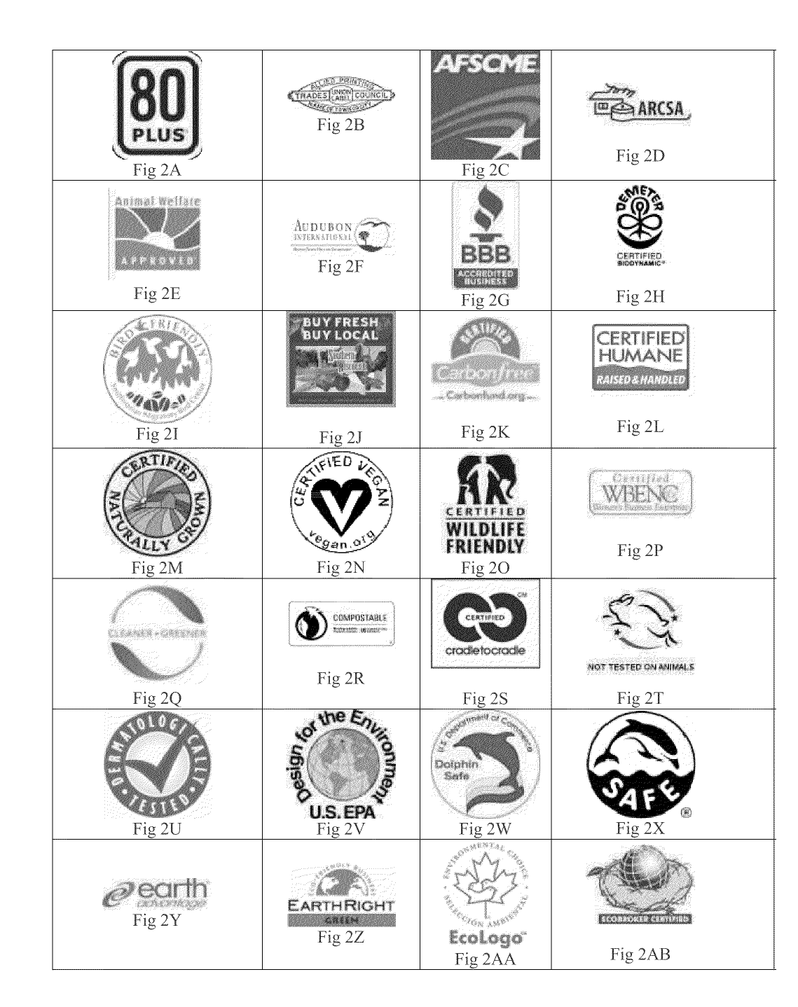

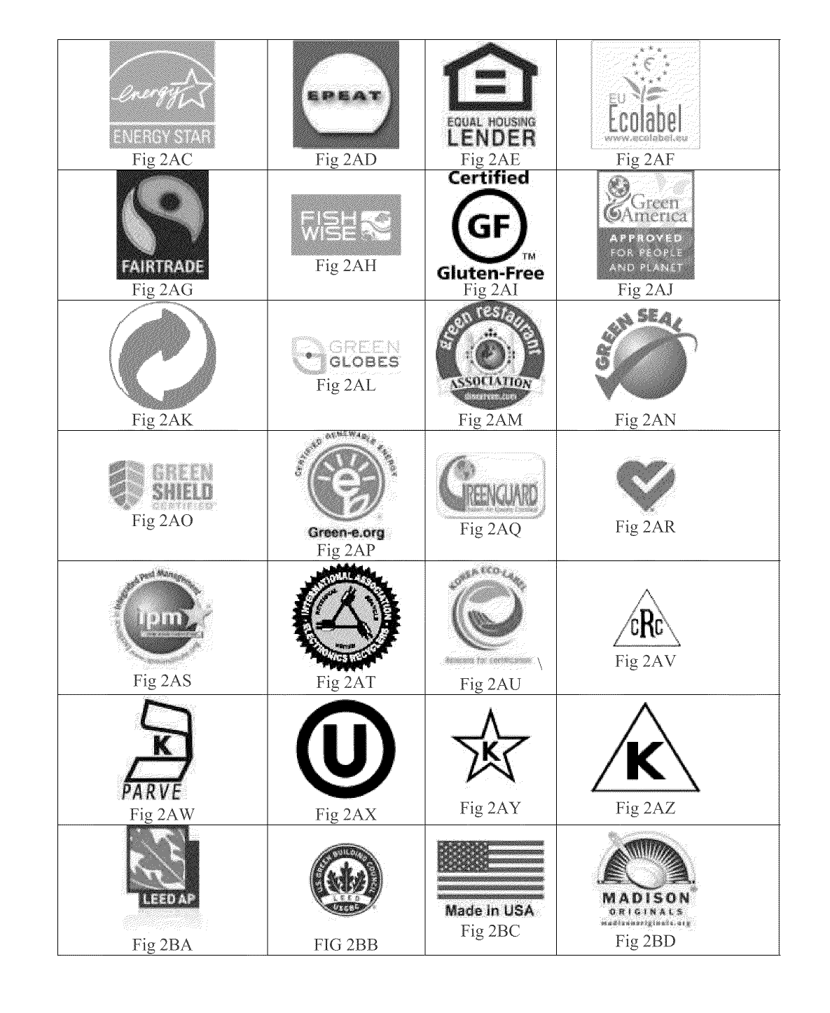

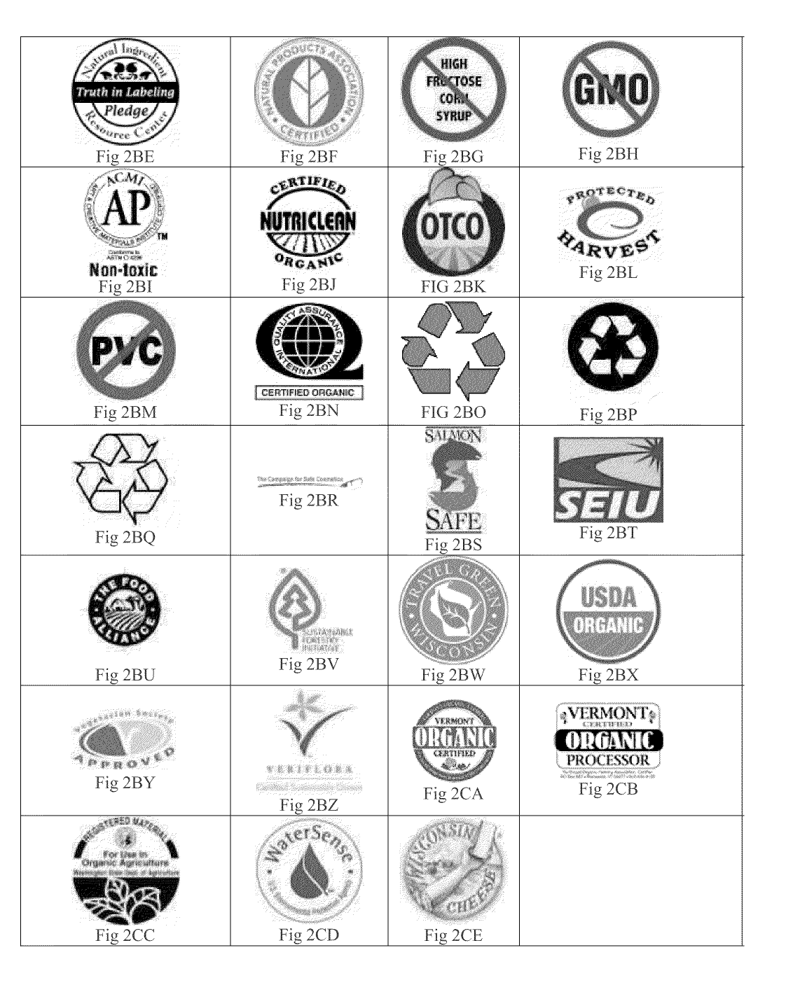

TABLE OF CERTIFICATIONS

| CERTIFICATIONS | NAME | DESCRIPTION |
|---|---|---|
| FIG. 2A | 80 PLUS | 80 PLUS is an innovative, electric utility-funded incentive program |
| | | to integrate more energy-efficient power supplies into desktop |
| | | computers and servers. Participating utilities and energy efficiency |
| | | organizations across North America have contributed over $5 million |
| | | of incentives to help the computer industry transition to 80 PLUS |
| | | certified power supplies. |
| FIG. 2B | Allied Printing | Printed products bearing an authentic Allied Printing Trades Council |
| | Trades Union (Bug) | label are symbols of the quality, skill, experience and pride that |
| | | union members put into their work every day. The union label |
| | | guarantees that the men and women who work on your project |
| | | receive fair wages and benefits in a plant which practices responsible |
| | | labor-management relations. Further, it represents an assurance of |
| | | quality and craftsmanship. The label must include the city name and |
| | | number identifying the exact union printing plant where the work |
| | | was produced. |
| FIG. 2C | American Federation | This label is used to represent products made by or workplaces |
| | of State County and | governed by the American Federation of State Country Municipal |
| | Municipal Employees | Employees Union. AFSCME has 1.6 million members in the |
| | Union | following professions: nurses, corrections officers, child care |
| | | providers, EMTs and sanitation workers. For AFSCME members, |
| | | public service is not just a job, it's a calling. |
| FIG. 2D | American Rainwater | Rainwater catchment - or “harvesting” - is an ancient practice |
| | Catchment Systems | now enjoying a revival as an alternate water supply. The practice |
| | Association | involved collecting rainwater from a roof or other surface before it |
| | | reaches the ground and Storing it for future use. ARCSA promotes |
| | | rainwater catchment systems in the United States through educational |
| | | opportunities and the exchange of information at our Web site and |
| | | through our workshops. Our membership consists of professionals |
| | | working in city, state, and federal government, academia, |
| | | manufacturers and suppliers of rainwater harvesting equipment, |
| | | consultants, and other interested individuals. Membership is not |
| | | limited to the US, and we encourage all rainwater harvesting |
| | | enthusiasts to join our organization. |
| FIG. 2E | Animal Welfare | The Animal Welfare Approved food label and program assure |
| | Approved | consumers that the animals were raised with the highest welfare |
| | | standards: raised on pasture, allowed to exhibit natural behaviors, not |
| | | fed routine antibiotics or growth hormones. Animal Welfare |
| | | Approved farms allow animals to behave naturally and socialize |
| | | freely. |
| FIG. 2F | Audubon | This program provides the assurance that audited lodging facilities |
| | International | have met environmental best practice standards that are required for a |
| | | rating of one to five Green Leafs. The program began in 1998 to |
| | | meet the lodging industry's desire to provide quality guest services, |
| | | while minimizing their impact on the environment. Through a |
| | | comprehensive and credible method for assessing the extent of the |
| | | environmental measures undertaken, participating facilities can |
| | | reduce environmentally-related costs and gain a marketing |
| | | advantage. By earning a rating in the Audubon Green Leaf ™ |
| | | Program, you're confirming your commitment to water quality, water |
| | | conservation, waste minimizatin, resource conservation, and energy |
| | | efficiency. |
| FIG. 2G | Better Business | BBB sees trust as a function of two primary factors - integrity and |
| | Bureau | performance. Integrity includes respect, ethics and intent. |
| | | Performance speaks to a business's track record of delivering results |
| | | in accordance with BBB standards and/or addressing customer |
| | | concerns in a timely, satisfactory manner. BBB ensures that high |
| | | standards for trust are set and maintained. We exist so consumers and |
| | | businesses alike have an unbiased source to guide them on matters of |
| | | trust. We provide educational information and expert advice that is |
| | | free of charge and easily accessible. BBB Accreditation is an honor - |
| | | and not every company is eligible. Businesses that meet our high |
| | | standards are invited to join BBB. Businesses meeting BBB |
| | | standards are presented to local Boards of Directors (or designees) |
| | | for review and acceptance as a BBB Accredited Business. |
| FIG. 2H | Biodynamic | Demeter ® USA is the only certification agent for Biodynamic ® |
| | | farms, processors and products in the United States. As a non-profit |
| | | organization, Demeter's mission is to improve the health of the |
| | | planet and its people by providing certification of products whose |
| | | ingredients are grown and processed according to the highest |
| | | agricultural and environmental standards. From farm to market, only |
| | | those companies that consistently meet these standards are permitted |
| | | to display the Demeter certification mark. Biodynamic ® farming is |
| | | free of synthetic pesticides and fertilizers in the same manner as |
| | | certified organic farming. In order to qualify for Demeter |
| | | Biodynamic ® status a farm must first meet the same 3-year transition |
| | | requirement that NOP certified organic farming requires. What |
| | | distinguishes a Demeter certified Biodynamic ® farm from a certified |
| | | organic farm is that, in its entirety, a Demeter Biodynamic farm is |
| | | managed as a living organism. |
| FIG. 2I | Bird Friendly Coffee | “Bird Friendly ®” coffees are the only coffees on the market that are |
| | | certified as 100% shade-grown and organic, meaning that they are |
| | | grown without the use of chemical pesticides that poison the |
| | | environment. Companies that sell coffee with the “Bird Friendly ®” |
| | | seal of approval contribute 25 cents per pound to support SMBC |
| | | research and conservation programs. |
| FIG. 2J | Buy Fresh Buy Local | Keeping our local farmers and producers in business supports our |
| | | local economy. Dollars spent close to home tend to stay close to |
| | | home. Our local producers understand our community and work to |
| | | provide nutritious affordable food for all our citizens. The more we |
| | | feel connected to the people who produce what we eat, the better we |
| | | preserve our regional food heritage. Rural and urban - we're all |
| | | connected. |
| FIG. 2K | Certified Carbon Free | The CarbonFree ® Partner program allows individuals and businesses |
| | | purchase carbon offsets. |
| FIG. 2L | Certified Humane | Designed to certify that animals raised for dairy, lamb, poultry and |
| | | beef products are treated in a humane manner. Traceability ensures |
| | | that that products come from the farms that were inspected. Access to |
| | | clean and sufficient food and water; and a safe and healthful living |
| | | environment is also required from birth through slaughter. Producers |
| | | also must comply with environmental standards. Under the program, |
| | | growth hormones are prohibited and animals are raised on a diet |
| | | without antibiotics. Antibiotics can be used in the treatment of sick |
| | | animals. The birds are uncaged inside barns or warehouses, but may |
| | | be kept indoors at all times. They must be able to perform natural |
| | | behaviors such as nesting, perching, and dust bathing. There are |
| | | requirements for stocking density and number of perches and nesting |
| | | boxes. Forced molting through starvation is prohibited, but beak |
| | | cutting is allowed. Compliance is verified through third-party |
| | | auditing. |
| FIG. 2M | Certified Naturally | Certified Naturally Grown is a non-profit alternative certification |
| | Grown | program tailored for small-scale, direct-market farmers using natural |
| | | methods. Nearly 700 farmers from 48 states are enrolled to use the |
| | | Certified Naturally Grown label. When USDA's Organic program |
| | | was implemented in 2002, many farms earning more than $5,000 per |
| | | year were forced to make a difficult choice: either pay high |
| | | certification fees and complete mounds of paperwork to become |
| | | Certified Organic, or else give up using the word “organic” to |
| | | describe their produce and/or livestock. Believing that neither choice |
| | | was very attractive, some farmers created Certified Naturally Grown |
| | | to provide an alternative way to assure their customers that they |
| | | observed strict growing practices. CNG strives to strengthen the |
| | | organic movement by removing financial barriers to certification that |
| | | tend to exclude smaller direct-market farms, while preserving high |
| | | standards for natural production methods. |
| FIG. 2N | Certified Vegan | The Logo is a registered trademark, similar in nature to the “kosher” |
| | | mark, for products that do not contain animal products and that have |
| | | not been tested on animals. The Logo is easily visible to consumers |
| | | interested in vegan products and helps vegans to shop without |
| | | constantly consulting ingredient lists; it helps companies recognize a |
| | | growing vegan market; and it helps bring the word “vegan” - and the |
| | | lifestyle it represents - into the mainstream. (Please keep in mind, |
| | | however, that the logo is not yet on every vegan product.) The Logo |
| | | is administered by The Vegan Awareness Foundation (official name |
| | | of Vegan Action), a 501(c)3 nonprofit organization dedicated to |
| | | educating the public about veganism and to assist vegan-friendly |
| | | businesses. |
| FIG. 2O | Certified Wildlife | The Wildlife Friendly Enterprise Network is a global community |
| | Friendly | dedicated to the development and marketing of products that |
| | | conserve threatened Wildlife while contributing to the economic |
| | | vitality of rural communities. |
| FIG. 2P | Certified Women's | WBENC Certification validates that the business is 51 percent |
| | Business Enterprise | owned, controlled, operated, and managed by a woman or women. |
| | | To achieve WBENC Certification, women owned businesses |
| | | complete a formal documentation and site visit process which is |
| | | administered by one of WBENC's 14 Regional Partner |
| | | Organizations. WBENC Certification gives women owned |
| | | businesses the ability to compete for real-time business opportunities |
| | | provided by WBENC Corporate Members. |
| FIG. 2Q | Cleaner and Greener | Today, individuals, businesses, organizations, industries, and |
| | Certification | governments are increasingly aware of the environmental impacts of |
| | | their actions. Global climate change in particular is a major concern |
| | | to many, and the main human contribution to climate change is fossil |
| | | fuel combustion. Fossil fuel combustion is also a major source of |
| | | emissions that are bad for human health. Greenhouse gases, |
| | | including carbon dioxide, methane, and nitrous oxide, and the air |
| | | pollutants that are harmful to human health are emitted from vehicles |
| | | we drive, planes we fly, natural gas furnaces and other appliances we |
| | | use, power plants that burn coal or other fuels to generate electricity |
| | | we use, and the production and transportation of products we buy. |
| | | Organizational and corporate stakeholders respond to these concerns |
| | | by undertaking emissions footprinting projects, which enable them to |
| | | understand the environmental impact on climate change and air |
| | | quality of an entire organization, a building, an event, or any |
| | | particular aspect of its operations (e.g. shipping, or one of its |
| | | products). |
| FIG. 2R | Compostable | The symbol is designed for use on products and packages. It is |
| | | designed to allow consumers, composters, waste haulers and officials |
| | | easily distinguish those plastic products designed to biodegrade |
| | | quickly, completely and safely, when composted in well-run |
| | | municipal and commercial facilities. No plastic residues will be left |
| | | behind to destroy the value of the finished compost. Products are |
| | | tested in approved, independent laboratories. BPl's scientists check |
| | | the data to verify that the products meet requirements in ASTM |
| | | Specifications D6400 or D6868. The ASTM Specifications used by |
| | | the BPI resulted from eight years of intensive work by leading |
| | | scientists, resin producers and the composting industry. Passing these |
| | | specifications mean that a product will biodegrade completely, |
| | | quickly and safely-just like yard trimmings and food scraps. ASTM |
| | | D6400 is designed to cover plastic films and bags. ASTM D6868 is |
| | | for packaging that is designed to be composted, including, plastic |
| | | coated paper and board. |
| FIG. 2S | Cradle to Cradle | Cradle to Cradle Certification provides a company with a means to |
| | | tangibly, credibly measure achievement in environmentally- |
| | | intelligent design and helps customers purchase and specify products |
| | | that are pursuing a broader definition of quality. This means using |
| | | environmentally safe and healthy materials; design for material |
| | | reutilization, such as recycling or composting; the use of renewable |
| | | energy and energy efficiency; efficient use of water, and maximum |
| | | water quality associated with production; and instituting strategies |
| | | for social responsibility. If a candidate product achieves the |
| | | necessary criteria, it is certified as a Basic, Silver, Gold or Platinum |
| | | product and can be branded as Cradle to Cradle CertifiedCM. |
| FIG. 2T | Cruelty Free | Signifies that a product is made by a company that adheres to the |
| | | Corporate Standard of Compassion for Animals, developed by the |
| | | Coalition for Consumer Information on Cosmetics, a coalition of |
| | | animal protection groups. The CCIC's purpose is to promote a |
| | | “cruelty-free” standard and logo. Website: |
| | | http://www.leapingbunny.org/ At first glance, one might think that |
| | | products labeled “cruelty-free” or “not tested on animals” would be |
| | | good choices. Unfortunately, this is not always true. The problem is |
| | | that “cruelty-free” is not clearly defined by law, so it can be used to |
| | | mean just about anything a manufacturer wants it to mean. Further |
| | | complicating the issue is the fact that many personal care products |
| | | not labeled “cruelty-free” are tested for safety using non-animal |
| | | methods, the same methods used by those companies marketing their |
| | | products as “cruelty-free”. |
| FIG. 2U | Dermatologically | There is no single agency that issues this label. It could be off |
| | Tested | different color or design. The words “Dermatologically Tested” on |
| | | the packaging means that the product has been tested on human skin. |
| | | However this does not necessarily mean the product (or it's |
| | | ingredients) were tested on animals. The European Union ban on |
| | | using animals to test cosmetics and their ingredients means that any |
| | | product manufactured within the EU has not been tested on animals. |
| FIG. 2V | Design for the | When you see the DfE logo on a product it means that the DfE |
| | Environment | scientific review team has screened each ingredient for potential |
| | | human health and environmental effects and that-based on currently |
| | | available information, EPA predictive models, and expert judgment- |
| | | the product contains only those ingredients that pose the least |
| | | concern among chemicals in their class. Product manufacturers who |
| | | become DfE partners, and earn the right to display the DfE logo on |
| | | recognized products, have invested heavily in research, development |
| | | and reformulation, to ensure that their ingredients and finished |
| | | product line up on the green end of the health and environmental |
| | | spectrum, while maintaining or improving product performance. |
| | | EPA's Design for the Environment Program (DfE) has allowed use of |
| | | their logo on hundreds of products. These products are formulated |
| | | from the safest possible ingredients and, in 2007, reduced the use of |
| | | “chemicals of concern” by 80 million pounds, up from 59 million |
| | | pounds in 2006. |
| FIG. 2W | Dolphin Safe | In 1999, the United States signed on as a Party to the Agreement on |
| | | the International Dolphin Conservation Program (AIDCP). Every |
| | | U.S. tuna purse seine vessel greater than 400 short tons carrying |
| | | capacity fishing in the ETP must have an IATTC approved observer |
| | | onboard to oversee every fishing trip. The vessel owners or |
| | | management of such vessels are responsible for notifying NMFS of |
| | | the location and expected time of arrival for each completed ETP |
| | | trip. |
| FIG. 2X | Dolphin Safe Earth | Earth Island Institute monitors tuna companies around the world to |
| | Island | ensure the tuna is caught by methods that do not harm dolphins and |
| | | protect the marine ecosystem. Our standards prevent harm to |
| | | dolphins and are adhered to by more than 90% of the world's tuna |
| | | companies. In order for tuna to be considered “Dolphin Safe”, if must |
| | | meet the following standards: 1. No intentional chasing, netting or |
| | | encirclement of dolphins during an entire tuna fishing trip; 2. No use |
| | | of drift gill nets to catch tuna; German Whale & Dolphin Foundation, |
| | | GRD logo 3. No accidental killing or serious injury to any dolphins |
| | | during net sets: 4. No mixing of dolphin-safe and dolphin-deadly |
| | | tuna in individual boat wells (for accidental kill of dolphins), or in |
| | | processing or storage facilities; and 5. Each trip in the Eastern |
| | | Tropical Pacific Ocean (ETP) by vessels 400 gross tons and above |
| | | must have an independent observer on board attesting to the |
| | | compliance with points (1) through (4) above. |
| FIG. 2Y | Earth Advantage | Earth Advantage has transformed itself over the past decade from a |
| | | utility-based energy conservation focus to a fully encompassed |
| | | sustainability program. We are now a free standing nonprofit |
| | | organization acting as the Northwest's premier green building |
| | | program. We work with builders and developers to bring the most |
| | | energy efficient, sustainable and healthy homes to the market. We |
| | | participate with other nonprofits, organizations and associations to |
| | | bring forth the message of conservation and sustainability. |
| FIG. 2Z | EarthRight Business | The EarthRight certification program is a graduated certification |
| | Certification | program structured to help organizations develop meaningful |
| | | environmentally sustainable business practices. EarthRight |
| | | certification demonstrates serious commitment and progress toward |
| | | eco-friendly business practices and significant environmental impact |
| | | reduction. EBI realizes that the effort toward improved |
| | | environmental practices is a progression. Through the EarthRight |
| | | program, EBI seeks to engage companies to: 1. Create a strong |
| | | commitment to pursue environmental improvements. 2. Develop |
| | | meaningful sustainability programs and goals. 3. Create |
| | | accountability for progress and achievement. As specific goals are |
| | | achieved, companies are rewarded with higher levels of certification. |
| FIG. 2AA | Eco Logo | EcoLogoTM is a third-party certified eco-labelling program |
| | | approved by the Global EcoLabelling Network (GEN)as a Type I |
| | | Label, according to the ISO 14024 Standard. Originally formed in |
| | | 1988 by the Canadian Federal Government, EcoLogo is now one of |
| | | the most recognizable eco-labels in North America. EcoLogo |
| | | standards endeavor to address multiple environmental attributes |
| | | related to both human health and environmental impacts across the |
| | | life cycle of a product or service. In doing so, EcoLogo only certifies |
| | | those products and services which represent environmental |
| | | leadership. After the standard is finalized, any manufacturer that |
| | | demonstrates compliance with the stringent requirements is eligible |
| | | for EcoLogo certification. Following a successful third-party audit of |
| | | the product against the standard's requirements, EcoLogo |
| | | certification can be claimed, and the product can bear the EcoLogo |
| | | mark. |
| FIG. 2AB | EcoBroker | Founded in 2002, EcoBroker is the first and largest green real estate |
| | | training and communications program in the world. With members in |
| | | all 50 United States, Canada, Mexico, the Caribbean, Central |
| | | America, and New Zealand, EcoBroker and its members serve real |
| | | estate consumers, communities, and the environment with an |
| | | unparalleled level of care, commitment, and follow-up. With the |
| | | benefit of oversight from the Association of Energy and |
| | | Environmental Real Estate Professionals (www.aeerep.org), |
| | | EcoBroker's green designation training and communications provide |
| | | professionals with the resources to be constructive green |
| | | ambassadors in an ever-changing business and consumer world. |
| | | EcoBroker offers education and tools to real estate professionals that |
| | | in turn help consumers take advantage of energy efficiency and |
| | | environmentally sensitive design in real estate properties. Through |
| | | EcoBroker's unique energy and environmental curriculum, real estate |
| | | professionals acquire the knowledge and resources to become |
| | | Certified EcoBrokers. These real estate professionals assist clients in |
| | | their pursuit of properties that provide affordability, comfort and a |
| | | healthier environment (reducing carbon footprints). In order to earn |
| | | the EcoBroker Designation, licensed real estate agents must fulfill a |
| | | straight-forward set of requirements. The most important requirement |
| | | of EcoBroker Certification is that you complete our energy, |
| | | environmental, and marketing training program. |
| FIG. 2AC | Energy Star | ENERGY STAR is a joint program of the U.S. Environmental |
| | | Protection Agency and the U.S. Department of Energy helping us all |
| | | save money and protect the environment through energy efficient |
| | | products and practices. |
| FIG. 2AD | EPEAT | EPEAT evaluates electronic products in relation to 51 total |
| | | environmental criteria, identified in the Criteria Table below and |
| | | contained in IEEE 1680 - 23 required criteria and 28 optional |
| | | criteria. To qualify for registration as an EPEAT product, the product |
| | | must conform to all the required criteria. Products are also ranked in |
| | | EPEAT according to three tiers of environmental performance - |
| | | Bronze, Silver, and Gold. All registered products must meet the |
| | | required criteria, and achieve Bronze status. |
| FIG. 2AE | Equal Housing | The terms Equal Housing Lender and Equal Opportunity Lender are |
| | Lender | synonymous and refer to all FDIC insured banks in the United States. |
| | | Such banks are prohibited from discriminating on the basis of race, |
| | | color, religion, national origin, sex, handicap, or familial status. They |
| | | are required, in all advertisements of home loan related services, to |
| | | explicitly use one of these two terms in describing themselves, or to |
| | | use one of several approved logos. This rule was introduced in the |
| | | Fair Housing Amendments Act of 1988 which amended the Fair |
| | | Housing Act of 1968. |
| FIG. 2AF | EU Ecolabel | Ecolabel criteria are not based on one single factor, but on studies |
| | | which analyse the impact of the product or service on the |
| | | environment throughout its life-cycle, starting from raw material |
| | | extraction in the pre-production stage, through to production, |
| | | distribution and disposal. The flower logo helps manufacturers, |
| | | retailers and service providers gain recognition for good standards, |
| | | while helping purchasers to make reliable choices. The EU Ecolabel |
| | | is part of a broader action plan on Sustainable Consumption and |
| | | Production and Sustainable Industrial Policy adopted by the |
| | | Commission on 16 Jul. 2008. |
| FIG. 2AG | Fair Trade | When a product carries the FAIRTRADE Mark it means the |
| | | producers and traders have met Fairtrade standards. The standards |
| | | are designed to address the imbalance of power in trading |
| | | relationships, unstable markets and the injustices of conventional |
| | | trade. Fair Trade enables the sustainable development and |
| | | empowerment of disadvantaged producers & workers in developing |
| | | countries through Fairtrade labeling. Fairtrade has over 2,700 |
| | | licensees - owners of brands that source from Fairtrade producers and |
| | | sell the final product with the Fairtrade Certification Mark. |
| FIG. 2AH | Fish Wise | |
| FIG. 2AI | Gluten Free Certified | Gluten-Free Certification Organization (GFCO) provides an |
| | | independent service to supervise gluten-free food production |
| | | according to a consistent, defined, science-based standard that is |
| | | confirmed by field inspections, in order to achieve heightened |
| | | consumer confidence and safety. GFCO envisions simplified |
| | | consumer identification of gluten-free foods based upon the presence |
| | | of the GF Certification Mark on product labels, and that this mark is |
| | | known as the gluten-free standard for consumers. GFCO seeks to |
| | | improve the health of those living on a gluten-free diet by providing |
| | | a system that ensures standards, which are based on sound scientific |
| | | research. |
| FIG. 2AJ | Green America | Our mission is to harness economic power - the strength of |
| | | consumers, investors, businesses, and the marketplace - to create a |
| | | socially just and environmentally sustainable society. |
| FIG. 2AK | Green Dot | The Green Dot, or Grüne Punkt, on an item of packaging means that |
| | | it complies with the German Packaging Ordinance for the return of |
| | | consumer packaging. The symbol can, in fact, be in any color other |
| | | than red. It is administered by Duales System Deutschland GmbH, a |
| | | non-profit organization which was established to enable |
| | | manufacturers and distributors to fulfill the requirements of the |
| | | legislation. This shows that a fee has been paid for the recovery of |
| | | the packaging in some European countries. |
| FIG. 2AL | Green Globes | The Green Globes system is used in Canada and the USA. In the |
| | | USA, Green Globes is owned and operated by the Green Building |
| | | Initiative (GBI). In Canada, the version for existing buildings is |
| | | owned and operated by BOMA Canada under the brand name |
| | | ‘BOMA BESt’. The Green Globes system has also been used by the |
| | | Continental Association for Building Automation (CABA) to power |
| | | a building intelligence tool, called Building Intelligence Quotient |
| | | (BiQ). In 2004, Green Globes for Existing Buildings was adopted by |
| | | the Building Owners and Managers Association of Canada (BOMA), |
| | | where it operates under the name BOMA BESt. In addition, the |
| | | Green Building Initiative (GBI) acquired the rights to distribute |
| | | Green Globes in the United States. The GBI has committed to |
| | | continually refining the system to ensure that it reflects ongoing |
| | | advances in research and technology, by involving stakeholders in an |
| | | open and transparent process. To that end, in 2005, GBI became the |
| | | first green building organization to be accredited as a standards |
| | | developer by the American National Standards Institute (ANSI), and |
| | | began the process of establishing Green Globes as an official ANSI |
| | | standard. The GBI ANSI technical committee was formed in early |
| | | 2006. Today, the Green Globes system is used by large developers |
| | | and property management companies, including, the Canadian |
| | | federal government, which has adopted BOMA BESt for its entire |
| | | real estate portfolio. |
| FIG. 2AM | Green Restaurant | The GRA's model provides a convenient way for all sectors of the |
| | Association | restaurant industry, which represents 10% of the U.S. economy, to |
| | | become more environmentally sustainable. The GRA utilizes a |
| | | collaborative strategy that involves restaurants, manufacturers, |
| | | vendors, grassroots organizations, government, media, and restaurant |
| | | customers. Certified restaurants must meet the following standards: |
| | | 1. Use a comprehensive recycling system for all products that are |
| | | accepted by local recycling companies. 2. Free of polystyrene foam |
| | | (“Styrofoam”) products. 3. Commit to completing four |
| | | Environmental Steps per year of membership. 4. Complete at least |
| | | one Environmental. Step after joining the GRA. |
| FIG. 2AN | Green Seal | A 501 (c)(3) nonprofit organization, Green Seal issued its first |
| | | environmental standards in 1991-2, and the first product |
| | | certifications were completed in 1992. Hundreds of products and |
| | | services from major companies such as 3M, Benjamin Moore, and |
| | | Andersen Windows have now been certified to meet Green Seal |
| | | standards, and the number of major product categories covered by |
| | | standards has increased to more than 40. |
| FIG. 2AO | Green Shield | Green Shield Certified is an independent, non-profit certification |
| | | program that promotes practitioners of effective, prevention-based |
| | | pest control while minimizing the use of pesticides. Green Shield |
| | | Certification sets IPM practitioners and facilities apart as truly green, |
| | | verified by an on-site audit. Certified practitioners focus on |
| | | correcting the conditions that lead to pest problems by using non- |
| | | chemical approaches first and the least amount of least-toxic |
| | | pesticides only when required to provide acceptable results. |
| FIG. 2AP | Green-e | Green-e is the nation's leading independent consumer protection |
| | | program for the sale of renewable energy and greenhouse gas |
| | | reductions in the retail market. Green-e offers certification and |
| | | verification of renewable energy and greenhouse gas mitigation |
| | | products. It is a program of the Center for Resource Solutions. |
| | | Certifies products in two markets: Green-e Energy: certifies |
| | | renewable energy certificates, Utility green pricing programs, and |
| | | competitive retail electricity providers. Green-e Climate: certifies |
| | | carbon offsets sold to consumers on retail markets. |
| FIG. 2AQ | GreenGuard | As an ANSI Accredited Standards Developer, GEI establishes |
| | | acceptable indoor air standards for indoor products, environments, |
| | | and buildings. GEI currently has three third-party certification |
| | | programs: 1. for Indoor Air Quality (low emitting interior building |
| | | materials, furnishings, and finish systems); 2. for Children & Schools |
| | | (low emitting interior building, materials, furnishings, and finish |
| | | systems used in schools); 3. for Building Construction (newly |
| | | constructed multifamily and commercial properties). |
| FIG. 2AR | Heart-Check Mark | Created by the American Heart Association, the Heart-Check Mark is |
| | | intended to help consumers develop a healthy diet and lifestyle to |
| | | fight cardiovascular disease. There are four categories for the label: |
| | | Standard (non-meat), Standard (meat and seafood, i.e., Extra Lean), |
| | | Whole Oats Soluble Fiber, and Whole Grain, heart-check mark |
| | | Whole Oats Soluble Fiber whole grain heart-check mark Whole |
| | | Grain |
| FIG. 2AS | Integrated Pest | The IPM Star Certification Program recognizes and rewards IPM |
| | Management (IPM) | practitioners who meet a high standard for IPM in schools, childcare |
| | Star Certification | centers and school-age programs. The program provides incentives |
| | | for everyone to reduce pest and pesticide risks to health and the |
| | | environment. IPM improves pest management results and reduces |
| | | liability and risks from both pests and pesticides. IPM STAR |
| | | certification is a voluntary step that clearly establishes your IPM |
| | | competence in a way that is readily recognized by others both in and |
| | | outside of your community. |
| FIG. 2AT | International | The IAER invested several years of effort to research, verify, and |
| | Association of | format a database on the electronics recycling industry. As a result, |
| | Electronics Recyclers | we have the most comprehensive, quality controlled database on |
| | | electronics recycling organizations available. As a service to IAER |
| | | Members as well as industry in general, the IAER developed a |
| | | searchable directory that uses that database. |
| FIG. 2AU | Korea Eco-Label | Korea Eco-labelling Program has been conducted from April 1992, |
| | | certifying Eco Labels to qualifying eco-products for excellent quality |
| | | and performance, as well as general environment-friendliness during |
| | | the entire production process. |
| FIG. 2AV | Kosher Chicago | cRc stands for Chicago Rabbinical Council, the largest regional, not- |
| | Rabbinical Council | for-profit, Orthodox organization in North America. In the 1930's, |
| | | the cRc developed a universally accepted agency with a respected |
| | | kosher certification symbol. The cRc's Kosher Division works with |
| | | close to 800 food companies, producing tens of thousands of |
| | | products across North and South America, Europe and Asia. Over 50 |
| | | years ago, Jays Potato Chips was one of the first companies certified |
| | | kosher by the cRc. |
| FIG. 2AW | Kosher Kof-K | The KOF-K symbol is the internationally recognized trademark of |
| | | KOF-K Kosher Supervision. Serving the Kosher consumer for |
| | | almost 40 years, KOF-K was the first Kashrus organization to |
| | | introduce computer technology to the complexities of Kashrus |
| | | supervision/management. In addition to automated inspection |
| | | “tracking,” the KOF-K has compiled a massive database of |
| | | ingredients and ingredient suppliers, accessed for companies under |
| | | KOF-K supervision. |
| FIG. 2AX | Kosher Orthodox | The OU symbol, belonging to the Orthodox Union, is one of the |
| | Union | strictest kosher standards on the market today. The OU has been |
| | | certifying kosher products for over 80 years. Their first kosher |
| | | certification went to Heinz. In 1923 Heinz Vegetarian Beans became |
| | | the first American product to display the OU kosher symbol. The |
| | | Bible lists the basic categories of food items which are not kosher. |
| | | These include certain animals, fowl and fish (such as pork and rabbit, |
| | | eagle and owl, catfish and sturgeon), most insects, and any shellfish |
| | | or reptile. In addition, kosher species of meat and fowl must be |
| | | slaughtered in a prescribed manner, and meat and dairy products may |
| | | not be manufactured or consumed together. |
| FIG. 2AY | Kosher Star-K | STAR-K Kosher Certification has provided kosher supervision for |
| | | over fifty years. The STAR-K, formerly known as the Orthodox |
| | | Jewish Council of Baltimore/Vaad Hakashrus, originally served the |
| | | Jewish community of Baltimore. Of the several hundred kosher |
| | | agencies in the world, Star-K is the only one that certifies |
| | | technology. For example, it was Star-K that certified the new kosher |
| | | consumer-friendly Connect Io ™ Refrigerated, Internet-Controlled |
| | | Electric Double Wall Oven, which includes separate Sabbath and |
| | | Holiday programmable modes. STAR-K is known as a leader in |
| | | integrating complex food technology with kosher laws. |
| FIG. 2AZ | Kosher Triangle-K | Kosher means ‘proper’, referring to foods which are acceptable to be |
| | | eaten by those of the Jewish faith who practice and observe certain |
| | | dietary laws as prescribed in the Torah, the Old Testament. Only the |
| | | meat of certain animals are kosher. These animals can be identified |
| | | as having split hooves and chewing their cud - animals such as cows |
| | | and sheep. Only chicken, duck, turkey, quail, Cornish hens, |
| | | doves/pigeons, geese, and pheasant are kosher. All fish with scales |
| | | and fins are kosher. All insects, crustaceans, shellfish, and other |
| | | invertebrates are NEVER considered to be kosher. |
| FIG. 2BA | LEED Accredited | In 2008, administration of the Professional Accreditation program |
| | Professional | transitioned to the Green Building Certification Institute (GBCI). |
| | | USGBC continues to provide support to aspiring and current LEED |
| | | APs and LEED Green Associates through education, study and |
| | | reference materials, and other resources that help you gain the |
| | | understanding of LEED you will need to become a LEED |
| | | Professional, as well as support GBCTs credentialing maintenance |
| | | requirements. |
| FIG. 2BB | LEED Certified | LEED certification provides independent, third-party verification that |
| | | a building project meets the highest green building and performance |
| | | measures. Sustainable building strategies should be considered early |
| | | in the development cycle. An integrated project team will include the |
| | | major stakeholders of the project such as the developer/owner, |
| | | architect, engineer, landscape architect, contractor, and asset and |
| | | property management staff. Implementing an integrated, systems- |
| | | oriented approach to green project design, development and |
| | | operations can yield synergies and improve the overall performance |
| | | of a building. |
| FIG. 2BC | Made in the USA | The Federal Trade Commission requires a product advertised as |
| | | Made in USA be “all or virtually all” made in the U.S. U.S. content |
| | | must be disclosed on automobiles and textile, wool, and fur products. |
| | | There's no law that requires most other products sold in the U.S. to |
| | | be marked or labeled Made in USA or have my other disclosure |
| | | about their amount of U.S. content. However, manufacturers and |
| | | marketers who choose to make claims about the amount of U.S. |
| | | content in their products must comply with the FTC's Made in USA |
| | | policy. Note: Products made in sweatshops in the American territory |
| | | of Saipan can carry this label. |
| FIG. 2BD | Madison Originals | Madison Originals is a non-profit association of local, independently |
| | | owned restaurants dedicated to preserving the areas unique local |
| | | flavor. |
| FIG. 2BE | Natural Ingredient | In order to display the Natural Ingredient Resource Center “Truth in |
| | Resource Center | Labeling” Pledge Seal, participants must voluntarily pledge to follow |
| | Truth in Labeling | the NIRC Criteria for labeling natural ingredients and products. |
| | Pledge | Participants who submit the pledge will be directed to a web page |
| | | where they can download the web graphic for display on qualifying |
| | | web sites, and a high resolution graphic for use on appropriate |
| | | product labels, brochures and other promotional material. This is a |
| | | voluntary program which is free of charge. The NIRC does not |
| | | certify ingredients, products or police compliance. Display of the |
| | | Seal does not in any way, imply endorsement by the NIRC. |
| FIG. 2BF | Natural Products | The NPA natural standard for home care products is based on natural |
| | Association Certified | ingredients, safety, responsibility and sustainability. * Natural |
| | | Ingredients. A product labeled “natural” should be made up of only, |
| | | or at least almost only, natural ingredients and be manufactured with |
| | | appropriate processes. * Safety: A product labeled “natural” should |
| | | avoid any ingredient that has peer-reviewed, scientific research |
| | | showing human health or environmental risk. * Responsibility: A |
| | | product labeled “natural” should use no animal testing in its |
| | | development except where required by law. * Sustainability: A |
| | | product labeled “natural” should use biodegradable ingredients and |
| | | the most environmentally sensitive packaging. |
| FIG. 2BG | No High Fructose | High-fructose corn syrup is a common sweetener and preservative in |
| | Corn Syrup | processed foods. High-fructose corn syrup is made by changing the |
| | | sugar (glucose) in cornstarch to fructose - another form of sugar. |
| | | The end product is a combination of fructose and glucose. Because it |
| | | extends the shelf life of processed foods and is cheaper than sugar, |
| | | high-fructose corn syrup has become a popular ingredient in many |
| | | sodas, fruit-flavored drinks and other processed foods. So far, |
| | | research has yielded conflicting results about the effects of high- |
| | | fructose corn syrup, but many consumers have chosen to limit the |
| | | amount of HFCS they consume. |
| FIG. 2BH | Non-GMO | Genetically modified (GM) foods, are food products that have had |
| | (Genetically | their DNA directly altered through genetic engineering. Companies |
| | Modified | may voluntarily label non-genetically modified food products as |
| | Organisims) | “non-GMO” or “MADE WITHOUT GENETICALLY MODIFIED |
| | | INGREDIENTS”. Meats, dairy products, farmed fish, and eggs are |
| | | usually from animals fed GM feed. To avoid GMO, buy CERTIFIED |
| | | ORGANIC. |
| FIG. 2BI | NonToxic Art & | Founded in 1936, ACMI was organized to assist its members in |
| | Creative Materials | providing the public with art and creative materials for children and |
| | Institute, Inc. | artists that are non-toxic. The Institute's members are art and creative |
| | Certified | material manufacturers, and currently there are over 210 members. |
| | | Of the 60,000 art and creative material formulations evaluated to |
| | | date, 100% of the children's products and 85% of those meant for the |
| | | adult artist are certified as non-toxic. All products in the program |
| | | undergo extensive toxicological evaluation and testing before they |
| | | are granted the right to bear the ACMI certification seals. |
| FIG. 2BJ | NutriClean | This rigorous certification program involves full disclosure of pest |
| | | management practices, evaluation of pest management practices, on- |
| | | site “worst-case” sampling of products, and laboratory testing to |
| | | confirm that there are no pesticide residues present at levels above |
| | | laboratory detection capabilities. This level of detection is 0.01 ppm |
| | | for most pesticides, and is generally 10 to 1,000 times more stringent |
| | | than required by law. Over the years, the Lab Tested and Certified |
| | | Pesticide Free program has linked innovative growers to retailers and |
| | | consumers who are interested in affordably priced food that meets |
| | | this unusually high standard. |
| FIG. 2BK | Oregon Tilth | Oregon Tilth is a nonprofit research and education membership |
| | | organization dedicated to biologically sound and socially equitable |
| | | agriculture. Oregon Tilth offers educational events throughout the |
| | | state of Oregon, and provides organic certification services to organic |
| | | growers, processors, and handlers internationally, Oregon Tilth |
| | | Certified Organic (OTCO) is an internationally recognized symbol of |
| | | organic integrity. OTCO provides a system that combines strict |
| | | production standards, on-site inspections, and legally binding |
| | | contracts to protect the producers and buyers of organic products. |
| FIG. 2BL | Protected Harvest | Protected Harvest is organized as an independent nonprofit |
| | | organization governed by a Sustainability Council of leading |
| | | environmental NGOs, scientists, and practitioners that approve |
| | | sustainability standards. Accredited certification firms conduct |
| | | annual audits and issue certification. Daily operations of Protected |
| | | Harvest are managed by SureHarvest. |
| FIG. 2BM | PVC Free | This label is not controlled by a single certification agency. PVC |
| | | (polyvinyl chloride) contains dioxins that are created in the |
| | | production process. Dioxins are carcinogenic and associated with |
| | | birth defects. L. L. Bean, Wal-Mart, Nike, Microsoft, Ikea, and |
| | | Johnson and Johnson, and dozens of other major companies, have |
| | | either phased out PVC, or are in the process of doing so. PVC is |
| | | currently found in thousands of products from children's toys, to |
| | | building materials, to inflatable boat coatings. |
| FIG. 2BN | Quality Assurace | QAI offers innovative, comprehensive certification programs that |
| | International | allow producers, trading companies, manufacturers, private labelers. |
| | Certified Organic | restaurants and retail distributors to guarantee their products meet the |
| | | regulatory guidelines or standards applicable to their specific needs. |
| FIG. 2BO | Recycling Mobius | The presence of what appears to be a recycling symbol does not |
| | Loop | necessarily mean that the product or material will be accepted |
| | | locally. Producers are increasingly manufacturing their goods for a |
| | | European or worldwide market and are obliged to include a variety |
| | | of potentially misleading symbols. Consumers should also be aware |
| | | that some symbols are not for their benefit, but for the waste |
| | | handling and disposal industry. The internationally-recognized |
| | | recycling symbol is the 3 chasing arrows icon, the Mobius Loop. |
| | | Each arrow represents an aspect of a successful recycling program: |
| | | collection, remanufacturing/reprocessing into a new product, and |
| | | finally purchase by the consumer. The symbol is only supposed to be |
| | | used on goods that are ‘recyclable’ or include ‘recycled content’, but it |
| | | has no precise meaning. This symbol may be found on a broad range |
| | | of products made of a variety of materials. |
| FIG. 2BP | Recycling Mobius | This Mobius Loop means that the product is made from recycled |
| | Loop | material. Without a qualifying statement, the symbol will be |
| | | interpreted to mean that the product is made from 100 percent post- |
| | | consumer waste. The symbol may also appear with the percentage of |
| | | recycled content, as long as this figure refers to the entire item. |
| FIG. 2BQ | Recycling Mobius | This Mobius Loop means that the product is recyclable. Without a |
| | Loop | qualifying statement, the symbol means that the entire product is |
| | | recyclable and that more than one-third of the population in the area |
| | | where it is distributed has convenient access to collection and drop- |
| | | off facilities. If the product does not meet this 33 percent |
| | | requirement, no claim should be made. |
| FIG. 2BR | Safe Cosmetics | When companies sign the Compact for Safe Cosmetics, they are |
| | Compact | pledging not only to make safer products, but also to provide greater |
| | | transparency to consumers about their products. By signing, |
| | | cosmetics manufacturers pledge that: 1. All cosmetics and personal |
| | | care products made by the company anywhere in the world meet or |
| | | exceed the formulation standards and deadlines set by the European |
| | | Union cosmetics directive to be free of chemicals that are known or |
| | | strongly suspected of causing cancer, mutation or birth defects. 2. |
| | | The company will implement substitution plans that replace |
| | | hazardous materials with safer alternatives within three years, and |
| | | publicly report its progress in meeting these goals. |
| FIG. 2BS | Salmon Safe | Salmon-Safe is an independent 501(c)3 nonprofit devoted to |
| | | restoring agricultural and urban watersheds so that salmon can spawn |
| | | and thrive, based in Portland, Oregon. |
| FIG. 2BT | Service Employees | This label is used to represent products made by or workplaces |
| | International Union | governed by the Service Employees International Union. SEIU is an |
| | | organization of 2.2 million members united by the belief in the |
| | | dignity and worth of workers and the services they provide and |
| | | dedicated to improving the lives of workers and their families and |
| | | creating a more just and humane society. They most likely represent |
| | | workers in the following industries: Healthcare, Public Services, and |
| | | Property Services. |
| FIG. 2BU | The Food Alliance | Food Alliance is a nonprofit organization that certifies farms, ranches |
| | | and food handlers for sustainable agricultural and facility |
| | | management practices. By choosing Food Alliance Certified |
| | | products, consumers and commercial food buyers can be assured |
| | | they are supporting safe and fair working conditions, humane |
| | | treatment of animals, and good environmental stewardship. |
| FIG. 2BV | The Sustainable | The Sustainable Forestry Initiative ® (SFI ®) label is a sign you are |
| | Forestry Initiative | buying wood and paper products from well-managed forests, backed |
| | | by a rigorous, third-party certification audit. |
| FIG. 2BW | Travel Green | Travel Green Wisconsin is a voluntary program that reviews, |
| | Wisconsin | certifies and recognizes tourism businesses and organizations that |
| | | have made a commitment to reducing their environmental impact. |
| | | Specifically, the program encourages participants to evaluate their |
| | | operations, set goals and take specific actions towards environmental, |
| | | social, and economic sustainability. Above all, the Travel Green |
| | | Wisconsin program is designed to protect the beauty and vitality of |
| | | Wisconsin's landscape and natural resources. Wisconsin's natural |
| | | resources, wildlife and cultural diversity are among its most |
| | | important tourism assets. Efforts to preserve them for future |
| | | generations serve the best interest of Wisconsin travelers, as well as |
| | | its tourism industry and the state's overall economy. The program is |
| | | also designed to educate travelers to Wisconsin about sustainable |
| | | tourism practices. It promotes smart business practices, giving the |
| | | state's tourism-related businesses and organizations a significant |
| | | point of differentiation from their competitors, and supports the |
| | | state's overall tourism brand. |
| FIG. 2BX | USDA Organic | The National Organic Program (NOP) develops, implements, and |
| | | administers national production, handling, and labeling standards for |
| | | organic agricultural products. The NOP also accredits the certifying |
| | | agents (foreign and domestic) who inspect organic production and |
| | | handling operations to certify that they meet USDA standards. |
| FIG. 2BY | Vegetarian Society | These products must be free from animal flesh (meat, fowl, fish or |
| | Approved | shellfish), meat or bone stock, animal or carcass fats, gelatin, aspic or |
| | | any other ingredients resulting from slaughter; contain only free |
| | | range eggs, where eggs are used; be free from genetically modified |
| | | organisms (GMOs); be cruelty free - no animal testing, and have no |
| | | cross contamination during the production process. |
| FIG. 2BZ | VeriFlora | VeriFlora is an agricultural sustainability certification and eco- |
| | | labeling program recognized as the gold-standard in the floriculture |
| | | and horticulture industries. The program is administered by Scientific |
| | | Certification Systems (SCS), a global third-party certifier of |
| | | environmental, sustainability and agricultural product quality claims. |
| | | Accredited under ISO/IEC Guide 65, the international standard for |
| | | third-party product certifiers, VeriFlora: <ul> <li>Delivers tangible |
| | | results that benefit growers, workers, consumers, the environment |
| | | and the bottom-line</li> <li>Meets the growing consumer demand |
| | | for sustainably grown cut flowers and potted plants</li> <li>Helps |
| | | assure product quality and longevity</li> </ul> |
| FIG. 2CA | Vermont Certified | This is the label of the Vermont Organic Farmer's (VOF). This |
| | Organic | “Certified Organic” label is found on products grown or raised in |
| | | Vermont which meet the standards of the USDA National Organic |
| | | Program. |
| FIG. 2CB | Vermont Certified | This is the label of the Vermont Organic Farmer's (VOF) for Food |
| | Organic Processor | Processors. In order to certify that food is organic at the retail level, |
| | | processors, packagers, manufacturers and food handlers must adhere |
| | | to USDA standards, which are as detailed and verifiable as the |
| | | farmer's certification process. |
| FIG. 2CC | Washington State | The WSDA Organic Food Program protects consumers and supports |
| | Department of | the organic food industry by ensuring the integrity of organic food |
| | Agriculture Organic | products through establishing organic standards and certifying |
| | | organic producers, processors, and handlers. |
| FIG. 2CD | WaterSense US EPA | WaterSense, a partnership program sponsored by the U.S. |
| | | Environmental Protection Agency, makes it easy for Americans to |
| | | save water and protect the environment. Look for the WaterSense |
| | | label to choose quality, water-efficient products. Many products are |
| | | available, and don't require a change in your lifestyle. Explore the |
| | | links below to learn about WaterSense labeled products, saving |
| | | water, and how businesses and organizations can partner with |
| | | WaterSense. |
| FIG. 2CE | Wisconsin Cheese | Created by the Wisconsin Milk Marketing Board, this logo visually |
| | | depicts Wisconsin's cheesemaking pride and heritage using the |
| | | phrase “Pride. Our Secret Ingredient (TM)”. The logo is not found on |
| | | all Wisconsin-produced cheese. Some companies that manufacture |
| | | products in Wisconsin also do so in other states and their packaging |
| | | and distribution systems don't allow for labeling by state of origin. |
| | | The logo will only be found on products made in a Wisconsin plant |
| | | by licensed Wisconsin cheesemakers. |

The system provides a platform for businesses and products to be dynamically linked to a variety of credentials for which can be applied to them. The greenness rating can be based upon one or more of the credentials that apply. It is contemplated that more rigorous credentials can have a greater weighting scale for purposes of the greenness rating. It is further contemplated that a taxonomy vocabulary for Eco-ranking using graphics can be applied to the business/non-profit/individual members. It is further contemplated that the taxonomies, relationships, and user interface elements that make pairing possible. Businesses can be able to form pair-relationships with one another within specific categories.

Environmentally conscious consumers find value in a greater knowledge base specific to sustainable and green information for the businesses they support. According to at least one embodiment of the present invention, the system 10 provides a multitude of information for each online business partner. The information is selected from the group including the business logo, logos of the business' partners, logos of the eco-labels associated with the business, photos of individual people who have paired with this business, manufacturing partners, sales partner information, use partners for the particular business, recycling partners for the particular business, a link to the business blog and consumer ratings for each business category.

According to at least one embodiment of the system 10, each consumer can have a unique profile generated from information they provide, their consumer interests and the businesses and products with which they are most frequently associated. By example, a multitude of information can be generated for each individual, which is selected from the group comprising a photo of the individual, suggested product pairs, suggested business pairs, suggested individual pairs, their paired products, their paired businesses, their paired individuals, the products they've reviewed, the number of products they've reviewed, how many businesses they've reviewed, a link to a blog feature, the non-profts they're paired with, their wishlist.

In addition to the businesses and individuals, information relating to various products can be helpful and considerably valuable when providing consumers the tools they desire to make more informed purchasing decisions. According to at least one embodiment of the present system 10, individual product information can be provided from a group comprising consumer ratings for each product category, links to the shopping cart where products can be purchased, photos of individual people who have paired with the business offering the product, location of where its manufactured, where the product is sold, what products it is used with, where it is recycled, other products made by the same business and news about the product.

Non-profit business can be profiled separately, according to at least one embodiment of the present invention. Information specific to non-profit businesses can be selected from the group comprising a photo of the non-profit logo, suggested individuals to pair with, suggested business partners, Current Members, People We Would Like to Join, Current Supporters, People Doing Good Work, paired products, paired businesses, paired individuals, products they've reviewed, how many products they're reviewed and how many businesses they've reviewed.

According to at least one embodiment of the present invention, a novel online retail system is provided. The online retail system is focused upon green products and users connected to green products. The term “green” can be used interchangeably with “environmentally friendly” and “environmentally sustainable”. The online retail system provides a platform for rating green products and services based upon a plurality of criteria. A product, service or business rating can be based upon a plurality of criteria selected from the group comprising consumer feedback and rating of a plurality of criteria, product/service green profile, business-to-business partner connections and relative comparisons to other products/services.

In an alternative embodiment, the “greenness rating” for a product/service is based solely upon user input. Users are selected from individual consumers interested in environmentally sustainable products and service, business users, and non-profit business users. The “greenness rating” is paired with information and data related to the level of “greenness” a product/service is attributed, which can include information relating to the supply chain and business partners associated with the product/service. By example, the supply chain information can include information about products from the raw materials, source, method of manufacturing, labor usage, country of origin, product packaging, shipping channels and additional steps until final usage of the product.

An additional feature available for providing consumers “greenness” data includes a supply chain and business partner mapping system. The mapping system dynamically provides a data rich visualization of product/service partners that are connected to a particular product/service. The consumer is able to dynamically identify supply chain and business partnering information associated with a particular product/service and/or business for purposes of associating a greenness factor that is aligned with their particular consumer interests.

In one embodiment, the system 10 provides for reciprocal pairing of at least two entities, which in certain embodiments are connected through online software or other wired or wireless communication means. Entities as herein described include, without limitation, individuals, businesses, products, services, certifications, organizations (including for-profit and not-for-profit organizations), government and other jurisdictional entities (e.g. towns, cities, water or sewer districts, state or national governing bodies, or international agencies including non-governmental organizations (NGOs)).

Reciprocal pairing involves the linking or connection of the at least two entities via inverse relationships, where inverse relationships are between entities that have a different status than one another, e.g. lawyer-client, parent-child, supplier-distributor, raw material supplier-processor, etc. Reciprocal pairing can extend along and create a chain of interrelated entities. For example, a cotton farmer can be paired with a processor (e.g. a textile mill), the processor paired with a clothing maker, and the clothing maker paired with the product such as a shirt. Ultimately, the cotton farmer can then be paired with the final product such as the shirt. In other embodiments, additional entities that can be paired include the consumer who buys the product, one or more shipping entities (e.g. rail or trucking firms), certification agencies (e.g. organic or union certifications), and these other entities would also be connected via reciprocal pairing to any of the other entities in the chain.

In one embodiment, an entity can log into the system 10 and create a reciprocal pairing with one or more entities that already exist (e.g. have a profile or are named) in the system 10. Each of the parties' designations (e.g. supplier, purchaser, consumer) is given relative to the entity that is viewing or logged into the system 10 at a particular time. In the above example, the textile mill (the processor) would be displayed on a farmer's profile as a buyer, whereas on the textile mill's profile the farmer would be displayed as a supplier. Thus, the status of a reciprocal pairing relationship is a function of the entity whose profile is being displayed.

It is specifically intended that the present invention not be limited to the embodiments and illustrations contained herein, but include modified forms of those embodiments including portions of the embodiments and combinations of elements of different embodiments as come within the scope of the following claims.

1. A method for providing on online consumer driven environmentally sustainable product database, comprising:
providing a greenness rating for at least one product and/or service;
providing a dynamically linked supply chain map of the at least one product and/or service; and
providing a platform for consumers to purchase the at least one product and/or service.

2. A method for providing a greenness product rating as described herein.

3. A system for environmentally sustainable and/or green product supply chain mapping as described herein.

4. A system for environmentally sustainable and/or green business to consumer relationship mapping as described herein.

5. A system for proactively providing connections that link related green goods and services as described herein.

6. A method for showing relationships between companies, non-profits, products, and people as described herein.

7. A system for providing a dynamic and interactive visualization greenness products and or services module as described herein.
